(19) United States
(12) Patent Application Publication
(10) Pub. No.: US 2006/0127748 A1
(43) Pub. Date: Jun. 15, 2006

(54) Battery adapter and method of making the same

(75) Inventor: Amaro Cabral, East Taunton, MA (US)

Correspondence Address: HOWREY LLP, C/O IP DOCKETING DEPARTMENT, 2941 FAIRVIEW PARK DR, SUITE 200, FALLS CHURCH, VA, 22042-2924, US

(73) Assignee: General Dynamics C4 Systems, Inc., Taunton, MA (US)

(21) Appl. No.: 11/010,421

(22) Filed: Dec. 14, 2004

(51) Int. Cl. H01M 2/10

(52) U.S. Cl. 429/100

(57) ABSTRACT

The present invention pertains to a battery adapter that may include a battery housing. The housing may be made essentially of a substantially rigid material. This housing may be configured to hold one or more batteries. A bottom portion may be provided and may be configured to be disposed at a first end of the housing. The bottom portion may include a venting portion configured to permit the flow of gasses from within the housing to the exterior of the housing. Alternatively, the venting portion may be located anywhere on the housing. A membrane may be disposed over the venting portion. This membrane may be configured to rupture when a high pressure builds up within the housing.

### FIELD OF THE INVENTION

The invention relates to battery adapters for use with battery-powered devices. More specifically, the present invention pertains to battery adapters that are configured to prevent injury in the event that a battery explodes within the battery adapter.

### BACKGROUND OF THE INVENTION

Many devices may be configured for use without having to be connected to an immobile power supply. Batteries having various voltage and current characteristics may power these devices. Thus, devices that otherwise may require, for example, an electrical outlet may be configured to run on battery power. Some examples of devices, such as, for example, hand-held devices that may be powered using battery power include, for example, global positioning systems (GPS), radio or telecommunications equipment, video equipment, and lighting, just to name a few.

Battery-powered devices may have both commercial applications and military applications. Exemplary batteries used in military applications include, for example, BA-5800, BB-2800, and BA-5680 batteries. These batteries may include lithium sulfur dioxide that may be sensitive to environmental conditions and may rupture. When a battery ruptures, the battery may vent gases, thus causing the housing holding the battery to become pressurized. High internal pressures within the housing holding the batteries may cause the housing to break and explode. Shrapnel may cause injury to an individual or individuals that are proximate to the battery housing.

One method for preventing the explosion of the housing is to create a weakness in the shell material of the housing. For example, the shell material may be a metal shell holding the battery or batteries. When a battery explodes, the housing may be configured to rupture at a predetermined point where the material was weakened. This configuration results in many drawbacks, including the possibility of failure of the material to rupture at the predetermined location thereby causing the housing to explode as if the material was not weakened. Additionally, even if the housing did rupture at the predetermined location, the point of rupture may have sharp edges that may cause cuts or may tear other equipment. Furthermore, the weakening of the housing causes a decrease in structural integrity of the device, which may lead to ruptures of the housing even when a battery within the housing does not fail.

What is needed is a battery adapter that is configured to allow gas to escape a housing holding the battery or batteries at a rapid rate without creating shrapnel that may injure the individual proximate to the battery-powered device. Additionally, what is needed is a battery adapter that will protect the battery and electrical connections from environmental conditions while permitting gases to escape the housing in the event that a battery explodes. Such a device may preferably be configured to avoid sharp edges after a batter explodes thereby making the battery adapter safer than prior art battery adapters.

### SUMMARY OF THE INVENTION

Thus, the present invention seeks to address at least some of the foregoing problems identified in prior art battery adapters. Thus, the present invention pertains to a battery adapter and a method of making the same. Furthermore, another aspect of the present invention may include an adapter configured to use various types of batteries within the same battery adapter assembly.

The invention according to a first aspect may include a tube. The tube may be made essentially of a substantially rigid material. This tube may be configured to hold one or more batteries. A bottom portion may be provided and may be configured to be disposed at a first end of the tube. The bottom portion may include a venting portion configured to permit the flow of gasses from within the tube to the exterior of the tube. Additionally, a membrane may be disposed over the venting portion. This membrane may be configured to rupture when a high pressure builds up within the tube.

The invention according to the first aspect may also include an interface. This interface may be configured to connect the apparatus to a device, such as, for example, a hand-held or other battery-powered device. One or more batteries may be provided within the apparatus to supply power to the device via the interface. According to some embodiments of the invention, a fastener may be provided to secure the apparatus on to or within the device. The membrane may be configured to rupture when a high pressure builds up within the tube. Furthermore, the membrane may be configured to substantially seal the inside of the tube from environmental moisture. The membrane may also be configured to permit self-regulation of atmospheric pressure within the tube due to changes in an environmental atmospheric pressure. One or more holes within the bottom portion may define the venting portion. The membrane may be disposed over the venting portion of the bottom portion such that the membrane is disposed within the tube when the bottom portion is affixed to the tube.

The invention according to an alternative embodiment may include a housing made of a substantially rigid material. The housing may be configured to hold one or more batteries.

The invention according to yet another embodiment of the present invention may include a method of making a battery adapter. This embodiment of the present invention may include providing a housing. The housing may be configured to hold a battery. A bottom portion may be provided and may be configured to be disposed at an end of the housing. This bottom portion may include a vent. A membrane may be disposed over the vent in the bottom portion. This membrane may be configured to rupture when a high pressure builds up within the housing.

### BRIEF DESCRIPTION OF THE DRAWINGS

While the specification concludes with claims particularly pointing out and distinctly claiming the present invention, it is believed the same will be better understood from the following description taken in conjunction with the accompanying drawings, which illustrate, in a non-limiting fashion, the best mode presently contemplated for carrying out the present invention, and in which like reference numerals designate like parts throughout the Figures, wherein:

FIG. 1 shows a battery adapter assembly according to one embodiment of the present invention;

FIG. 2 shows a cross-sectional view of a battery adapter assembly according to an embodiment of the present invention;

FIG. 3 shows a bottom view of a battery adapter with the bottom portion and various covers and housing sections removed according to an embodiment of the present invention;

FIG. 4 shows a cross-sectional view of another battery adapter according to another embodiment of the present invention;

FIG. 5 shows a bottom view of a battery adapter without the bottom portion according to another embodiment of the present invention;

FIG. 6 shows a top view of a battery adapter according to an embodiment of the present invention;

FIG. 7 shows a perspective view of a bottom portion of a battery adapter according to an embodiment of the present invention;

FIG. 8 shows a plan view of a bottom portion of a battery adapter according to an embodiment of the present invention;

FIG. 9 shows a vent configuration according to one embodiment of the present invention;

FIG. 10 shows a conductor for use in a battery adapter in accordance with an embodiment of the present invention with the wiring removed;

FIG. 11 shows a conductor for use in a battery adapter in accordance with an embodiment of the present invention with the wiring present;

FIG. 12 shows a top view of a conductor assembly according to an embodiment of the present invention;

FIG. 13 shows a bottom view of a conductor assembly according to an embodiment of the present invention; and

FIG. 14 shows a bottom view of a conductor according to an embodiment of the present invention.

### DETAILED DESCRIPTION OF THE INVENTION

The present disclosure will now be described more fully with reference to the Figures in which various embodiments of the present invention are shown. The subject matter of this disclosure may, however, be embodied in many different forms and should not be construed as being limited to the embodiments set forth herein.

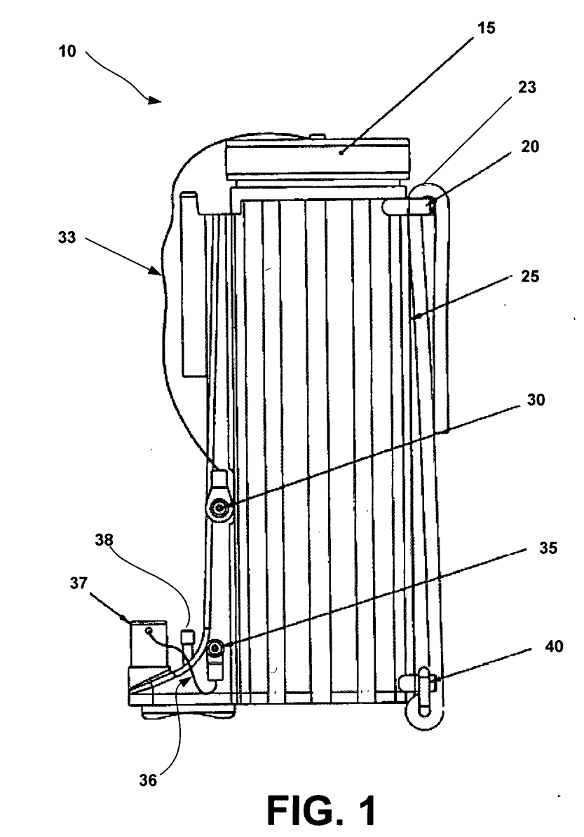

FIG. 1 shows a battery adapter assembly according to one embodiment of the present invention. A battery adapter assembly 10 according to the present invention may include a housing 25 configured to hold one or more batteries (not shown). The housing 25 may be tubular in shape. Alternative housing 25 configurations are possible so long as the housing 25 is configured to hold one or more batteries. According to one embodiment of the present invention, the housing 25 may be configured to house one or more BA-5800, BB-2800, or BA-5680 batteries or multiple 2/3A or AA batteries (not shown). The housing 25 may have a first end and a second end. A cap 15 may be disposed at a first end of the housing 25. The cap 15 may be configured to permit a user of the battery adapter assembly 10 to change the batteries within the housing 25. According to one embodiment of the present invention, the cap 15 may be threaded onto the housing 25. Additional configurations and modes of securing a cap on the housing 25 are known in the art and may be used in connection with the present invention. According to one embodiment of the invention, the housing 25 may have an upper hand strap bracket 20 and a lower hand strap bracket 40, configured to hold hand strap 23 in place. The hand strap 23 may be made of, for example, a fabric or a plastic material. Additionally, the hand strap 23 may include a hook and loop-type fastener material to make the hand strap 23 adjustable. The hook and loop fastener material may be, for example, Velcro™. A rope and eyelet 33 may be configured to pass from the cap 15 to a retention clip 30 that is configured to hold the rope and eyelet 33, thereby preventing the cap 15 from being displaced from the housing 25 while batteries are being exchanged. An additional retention clip 35 may be configured to hold another rope and eyelet 36 to retain the interface dust boot 37. According to one embodiment of the invention, the interface dust boot 37 may be made of a material such as, for example, rubber. Alternatively, a material such as plastic or metal may be used. The interface 91 as shown here may be configured to interface with a device configured to use battery power. According to one embodiment of the present invention, the device may be a hand-held device such as, for example, a GPS system or night-vision equipment. The battery adapter assembly 10 may be configured to interface with any device configured to operate on battery power. Additionally, an optional thumb screw 38 may be used to couple the battery adapter to a device, such as, for example, a hand-held device.

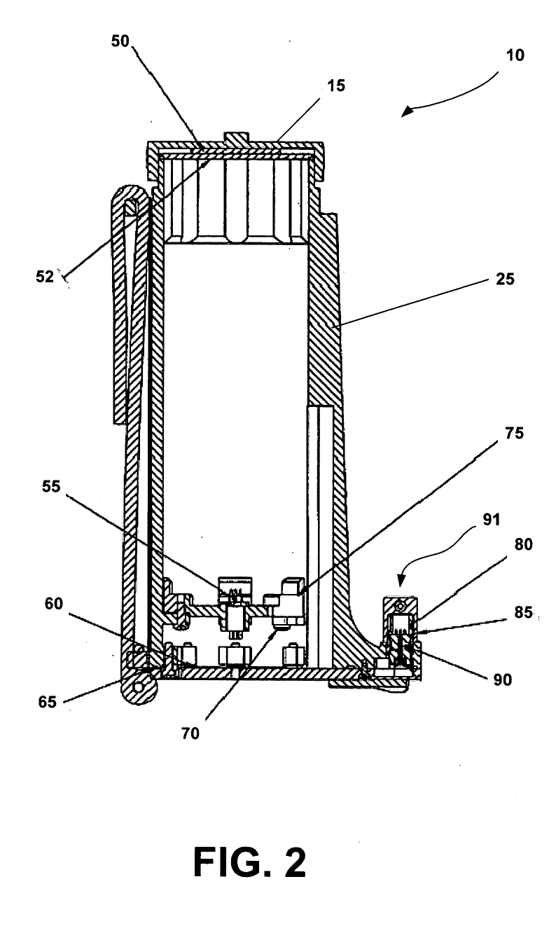

While a particular embodiment of the battery adapter assembly is shown in FIG. 1, one of ordinary skill in the art will understand that multiple configurations of a battery adapter shown in FIG. 1 may be employed. Additionally, the electrical wiring may reside within the housing or within wire guides located on the housing. All that is required is that a difference in electrical potential be created across the contacts of the interface 91 (as shown in FIG. 2).

FIG. 2 shows a cross-sectional view of a battery adapter assembly according to an embodiment of the present invention. A battery adapter assembly 10 according to the present invention may include, for example, a seating member 50. The seating member 50 may assist in ensuring that the cap 15 securely forces contact of the battery (not shown) within the battery tube 25. The seating member 15 may be, for example, an o-ring or a foam ring disposed proximate to the interface between the cap 15 and the housing 25. The seating member may be biased against the cap via, for example, a spring (not shown). Additionally, the battery adapter assembly may also include a gasket 52. The gasket 52 may be made of, for example, rubber or other suitable material. The gasket 52 may be configured to prevent the introduction of moisture or other materials, such as, for example, sand or dust, into the housing 25 in hostile environmental conditions.

The battery adapter assembly 10 may be configured to include a mating member 55. The mating member 55 may be configured to contact the batteries within the housing 25. Mating member 55 may be configured to mate with different types of batteries. The types of batteries used in the battery adapter assembly 10 may be dictated by the requirements of the device to be powered. A contact plate 75 may be mounted to structural support members, such as, for example, bosses disposed within the housing 25 via hardware 70, such as, for example, a screw, rivet or bolt. The bosses may be configured to support the contact plate 75 thereby supporting the batteries located within the housing 25. A gasket 65, such as an o-ring may be used to create a seal between the bottom portion 61 to the housing 25. A membrane 60 may be positioned on the bottom portion 61. The membrane 60 may be disposed over a vent portion (not shown) such that the membrane prevents the introduction of foreign materials into the housing 25. The membrane 60 may be configured to rupture when the pressure within the housing 25 builds up to approximately predetermined amount. The term “approximately” is used here to indicate that the membrane need not be designed to rupture at a given pressure, only that there is a relatively high probability of rupture when a predetermined pressure is attained. The predetermined amount may be, for example, 500 psi, 1000 psi, 1500 psi or more. This pressure may be attained when, for example, a battery explodes within the housing 25. The membrane 60 may be, for example, could be a Gore™ expanded PTFE woven membrane vent from W.L. Gore & Associates. Any material that allows air and gases to pass through it while blocking the passage of liquids, such as water may be employed to achieve the same result. Another configuration may employ a small Gore™ expanded PTFE woven membrane vent for normal tube aspiration along with a rubber vent that will tear when high pressure is attained from an exploding battery. The rubber vent may be bonded to the bottom portion 61. Additionally, the membrane 60 may be adhesive backed and may be configured to adhere to the bottom portion 61 of the housing 25 and may completely cover the venting portion within the bottom portion 61. When reference is made to the membrane rupturing, this is intended to include the situation in which internal pressures either break the seal formed by the adhesive or other fastening means between the housing and the membrane or tear the Gore™ or rubber vent.

The battery adapter assembly 10 may include an interface 91. The interface 91 may include a power connector 90. The power connector 90 may be configured to interface with a hand-held device (not shown) to thereby supply power across the terminals of the power connector 90. The interface 91 may also include a plug shell 80, which is configured to guide a corresponding interface 91 on the device into a mating arrangement with the power connector 90. The plug shell 80 may also provide structural protection for the power connector 90. A boot 85 may be disposed over the plug shell 80 and the power connector 90 when the battery adapter assembly 10 is not interfaced with a device. This boot 85 may be made of, for example, rubber or other suitable materials. Other types of cap devices may be used as boot 85, such as rubber or plastic caps, or metal caps.

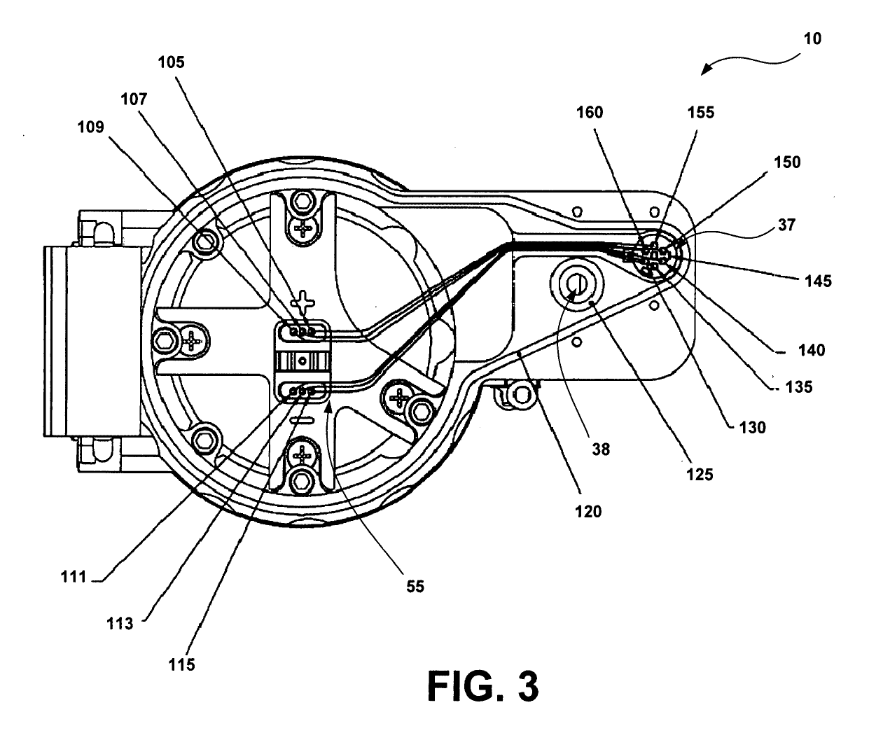

FIG. 3 shows a bottom view of a battery adapter with the bottom portion and various cover sections removed according to an embodiment of the present invention. FIG. 3 shows the underside of the mating member 55. As shown, mating member 55 may include a number of pins 105, 107, 109 and 111, 113, and 115 configured to be coupled to a corresponding number of wires to create an electric potential across the terminals of the power connector of interface 37. The interface may also have a number of pins 130, 135, 140, 145, 150, 155, and 160 configured to receive the wires connected to pins 105, 107, 109, 111, 113, and 115 so that the potential difference across the terminals of the power connector of interface 37. These wires may be soldered in place, for example. Other methods of connecting wires to terminals are well known in the art as will be recognized by the ordinarily skilled artisan. As show in FIG. 3, groove 120 may be disposed within the battery adapter assembly 10. The groove 120 may be configured to hold the gasket, such as, for example, an o-ring such that the bottom portion (not shown) is coupled to the housing in a substantially sealed manner. The battery adapter assembly may also be configured to have a thumb screw 38, which may be configured to engage a threaded receiving portion on a device, such as, for example, a hand-held device. The thumb screw 38 may be sealed against the device via an o-ring which may be disposed in an o-ring groove 125 within the battery adapter assembly 10.

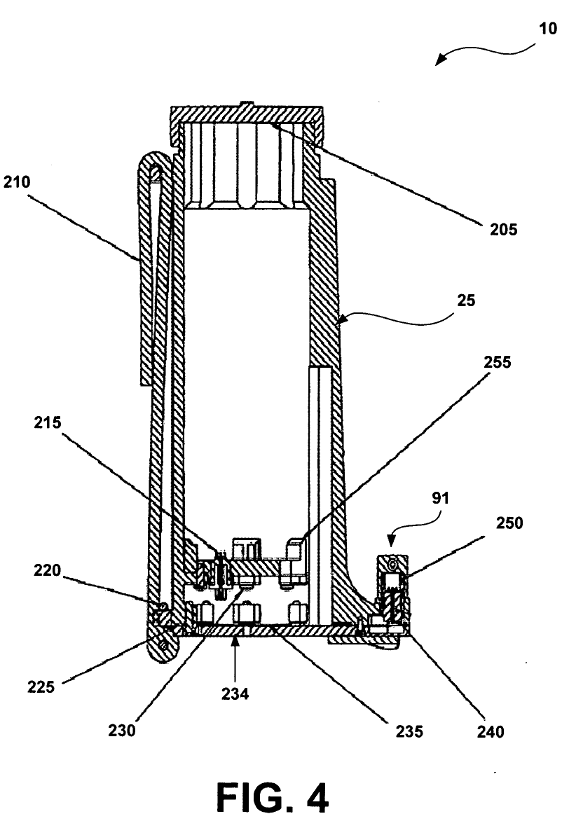

FIG. 4 shows a cross-sectional view of another battery adapter according to another embodiment of the present invention. The embodiment of the present invention illustrated in FIG. 4 is similar to that illustrated in FIGS. 2 and 3 in that the components are substantially the same. For example, like the embodiment of the invention shown in FIG. 2, the embodiment shown in FIG. 4 may include a cap 205 affixed to one end of a housing 25. The cap 205 may be configured to be threaded on the housing 25, for example. Other means of securing the cap 205 to the housing 25 are known in the art and may be employed rather than threading the cap 205 on the housing 25. For example, various clamps may be used as a substitute or in addition to the threading of the cap 205 onto the housing 205. As shown in FIG. 4, the present invention may also include an interface 91 having a power connector 240 surrounded by a shell and a boot 250 thereby protecting the power connector 240. The embodiment shown in FIG. 4 may also include a hand strap 210. The hand strap 210 may be an adjustable hand strap as discussed in more detail above. The hand strap may be affixed to housing 25 via a hand strap bracket 220. Additionally, as discussed with respect to FIG. 2, above, a gasket, such as, for example, an o-ring may be used to seal the bottom portion 234 to the housing 25. The gasket may be made of any suitable materials, including, for example, rubber. A membrane 235 may be disposed over a venting portion (not shown), which is part of the bottom portion 234. The membrane 235 may be configured to rupture when a pressure within the housing 25 approximates a predetermined pressure due to, for example the failure and explosion of a battery located within the housing. The pressure may be any pressure and the membrane may be configured with different properties depending on the desired rupture pressures.

The embodiment shown in FIG. 4 differs from that shown in FIGS. 2 and 3 in that the mating member 215 and the connectors to hold the bosses, such as boss 255, are shifted laterally. These bosses may be configured to support the batteries within the housing 25. This will permit the embodiment shown in FIG. 4 to hold different batteries than the embodiment shown in FIGS. 2 and 3. This battery adapter may be designed to hold the BB-2800 battery or configurations of 2/3A or AA batteries. Additionally, according to one aspect, the battery adapter may be configured to prevent the use of the BA-5800 and BA-5680 battery where safety requirements might not permit the use of these batteries.

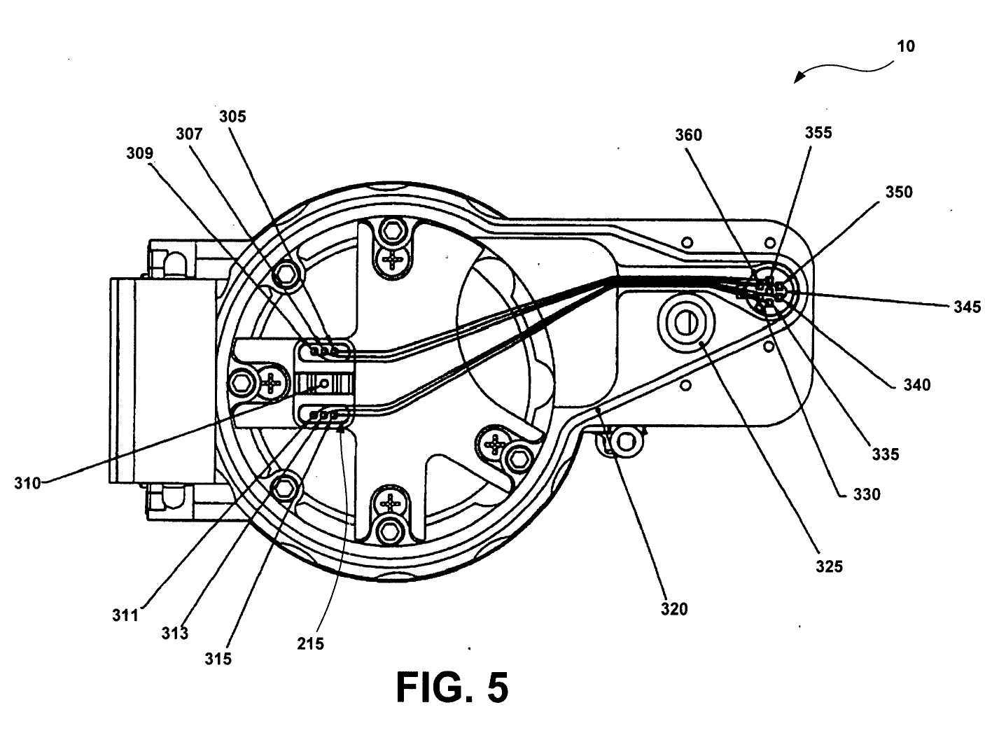

FIG. 5 shows a bottom view of a battery adapter without the bottom portion according to another embodiment of the present invention. The embodiment of the present invention shown in FIG. 5 is similar to that shown in FIG. 3 and is the bottom view of the embodiment shown in FIG. 4. As described with respect to FIG. 3, the batter adapter assembly 10 may include a mating member 215 that is configured to engage the battery and thereby create a potential difference across the terminals of the battery adapter at the interface. The reverse side of mating member 215 may include number of pins 305, 307, 309, 311, 313, and 315, which may be connected to wires to thereby establish an electrical potential difference across the terminals of the interface. The mating member 215 may be secured to the structure of the battery adapter assembly 10 using, for example, a rivet 310 or other type of physical connector. The type of physical connector used to couple the mating member to the structure of the batter adapter assembly is not critical to the practice to the present invention. Wires may be used to electrically connect the pins 305, 307, 309, 311, 313, and 315 with the pins associated with the interface device 330, 335, 340, 345, 350, 355, and 360. The pins may be electrically coupled to the power connector (not shown) to provide a voltage difference across the terminals of the power connector to thereby supply electrical power to a battery-powered device. As discussed above with respect to FIG. 3, the bottom portion of the battery adapter assembly 10 may include an o-ring groove 320 such that an o-ring may be positioned between a bottom portion and the housing. Additionally, an o-ring 325 may be positioned to seal the inside of the housing about the thumb screw that is used to connect the battery adapter assembly to a device.

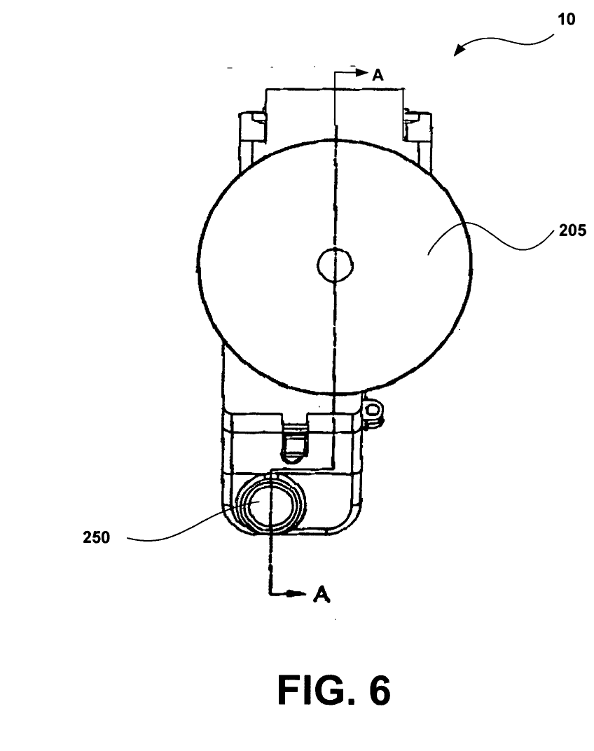

FIG. 6 shows a top view of a battery adapter according to an embodiment of the present invention. The cross-sectional views of the battery adapter assembly 10 as shown in FIGS. 2 and 4 are taken along the cross-section connoted by the letter “A”. As shown in FIG. 6, a cap 205 may be disposed on a battery adapter housing. The cap 205 may be secured to the housing by threads or other means for holding the cap on such as, for example, clamps, fasteners such as thumb screws, or the like. The interface 250 is also shown in FIG. 6. Interface 250 may have a protective cover disposed over the power connectors to prevent damage to the connector. The protective cover may be, for example, a rubber boot or a plastic or rubber fitting.

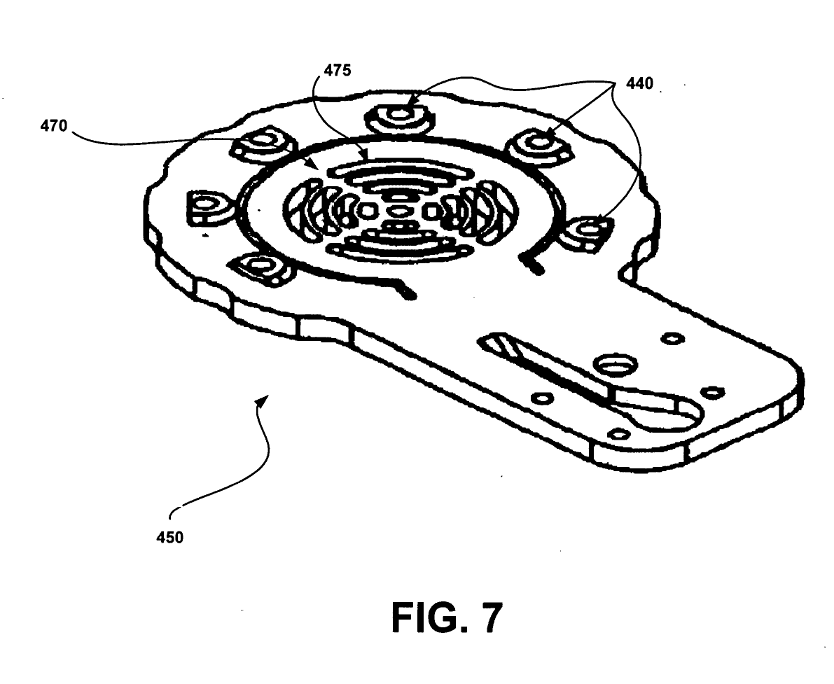

FIG. 7 shows a perspective view of a bottom portion of a battery adapter according to an embodiment of the present invention. As shown in FIG. 7, the bottom portion 450 of a battery adapter according to the present invention may include a venting portion 470. The venting portion may include a number of individual holes 475. These holes may be cut into the bottom portion 470. The bottom portion 450 of the battery adapter assembly may be made of a substantially rigid material such as a metal, such as, for example, aluminum. Individual holes 440 may be bored through the bottom portion 450 to allow fasteners to be used to secure the bottom portion 450 onto the housing of the battery adapter assembly. In one embodiment of the invention, six holes 440 may be bored through the bottom portion 450 to ensure the structural integrity of the battery adapter assembly. As will be understood by one skilled in the art, however, any number of holes 440 may be bored through the bottom portion 450 so long as the bottom portion remains structurally intact in the event that a battery explodes within the housing. The holes 440 may be designed such that the pressure within the housing may be relieved while substantially maintaining the structural integrity of the battery adapter assembly. Another embodiment of the vent replaces the vent holes 475 with a rubber vent with strategically placed tear lines that allow the rubber vent to open in the event a battery explodes.

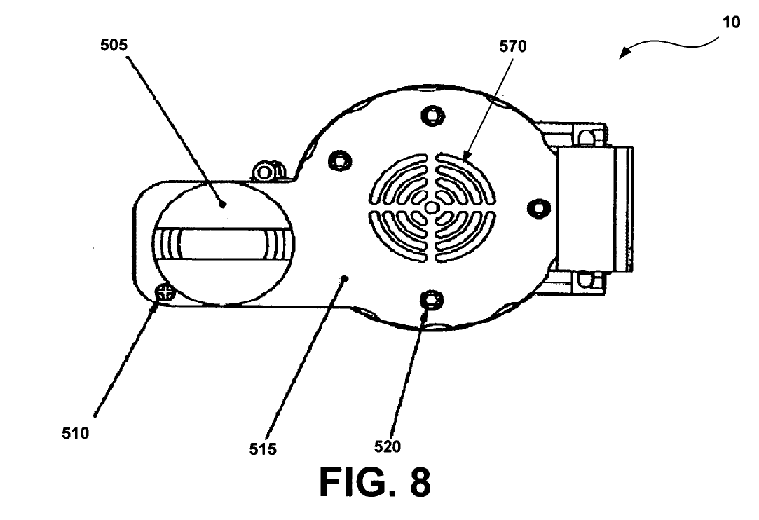

FIG. 8 shows a plan view of a bottom portion of a battery adapter according to an embodiment of the present invention. As shown in FIG. 8, a battery adapter assembly 10 may include a bottom portion 515. The bottom portion 515 may be formed from a substantially rigid material and may be integral to the battery adapter assembly 10 or, as shown in FIG. 8, may be a separate plate and may be bolted or otherwise affixed to the housing of the battery adapter assembly 10. The bottom portion 515 may have a venting portion 570. The venting portion 570 may include a number of holes cut into the bottom portion 515. The bottom portion may be affixed to the battery adapter assembly 10 by a number of fasteners 510 520. For example, as shown in FIG. 8, four screws 520 may be used to connect the bottom portion 515 to the housing. The battery adapter assembly 10 may include a thumbscrew 505. The thumbscrew 505 may be configured to engage a threaded female portion on a device and may be configured to secure the battery adapter assembly 10 on to the device.

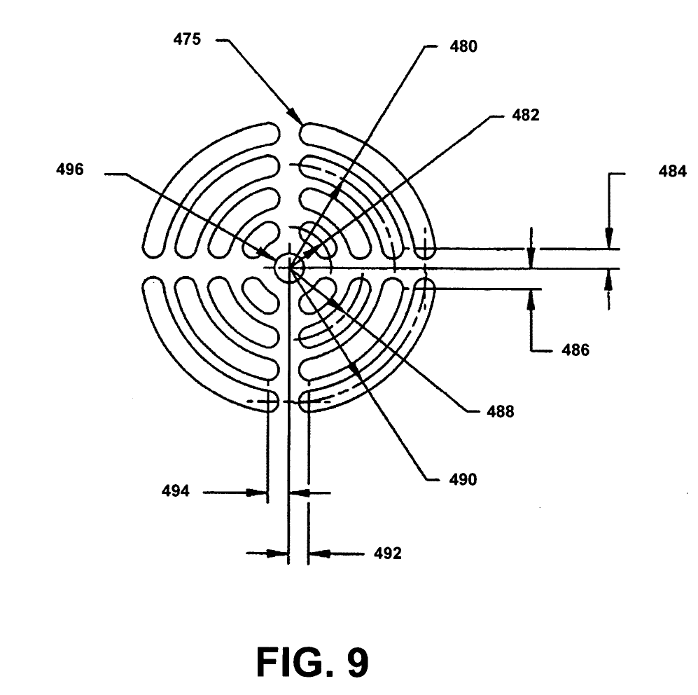

FIG. 9 shows a vent configuration according to one embodiment of the present invention. The vent configuration may have curved grooves or holes 475. One exemplary embodiment of a vent configuration is shown in FIG. 9, however, this embodiment is in no way intended to be limiting on the venting configurations. The present inventors have found that the following venting pattern was effective in meeting regulations and standards. The arc diameter 475 for each of the venting holes may be, for example, 0.031 inches. The spacing between the holes from the centers of the pattern to the center point of the arcs at the ends of the holes, identified as 484, 486, 492, and 494 may be, for example, 0.061 inches. The radius from the center of the venting pattern to the center of the inner most holes, identified as 482, may be, for example, one-eighth of an inch. The radius from the center of the venting pattern to the center of the second set of holes, identified as 488, may be, for example, 0.219 inch. The radius from the center of the venting pattern to the center of the third set of holes, identified as 480, may be, for example, 0.312 inches. The radius from the center of the venting pattern to the center of the outer most holes, identified as 490, may be, for example, 0.406 inches. The diameter of the inner circle 496 within the venting pattern may be, for example, 0.089 inches. Various venting patterns may be utilized so long as the structural integrity of the bottom portion of the battery adapter assembly is maintained.

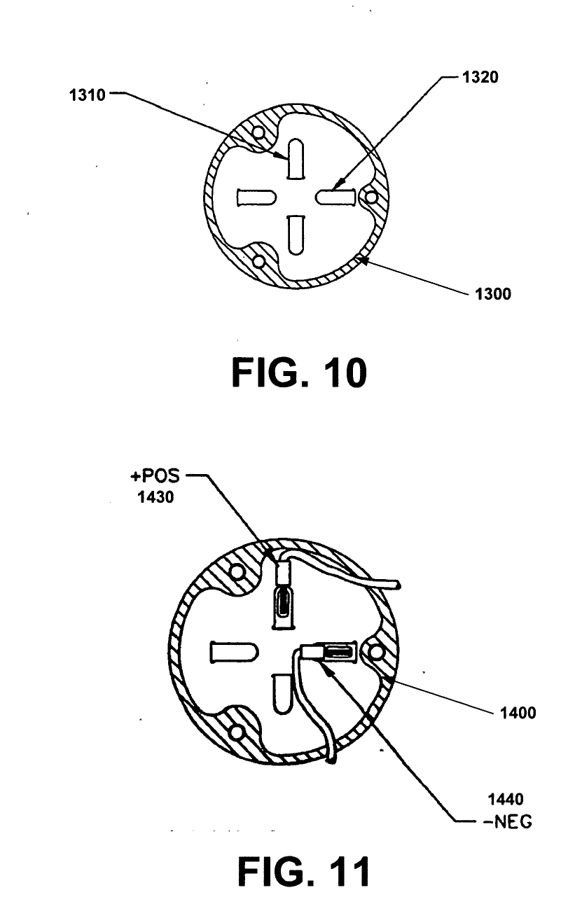

FIG. 10 shows a bottom cap 1300 for use in a battery adapter in accordance with an embodiment of the present invention with the wiring removed. The bottom 1300 may include a number of conductive tabs 1310 and 1320. Tabs 1310 may be folded outwardly and tabs 1320 may be folded inwardly. The tabs 1310 and 1320 may be configured in this manner to prevent the vertical tabs from contacting the horizontal tabs, thereby preventing a short across the positive and negative terminals. FIG. 11 shows a conductor for use in a battery adapter in accordance with an embodiment of the present invention with the wiring present. As shown in FIG. 11, a positive terminal 1430 may be constructed using the outwardly bent tabs shown in FIG. 10 and a negative terminal 1440 may be constructed using the inwardly bent tabs shown in FIG. 10. FIG. 13 shows a bottom view of the battery adapter illustrating its external contact arrangement according to an embodiment of the present invention. As shown in FIG. 13, the bottom cap 1300 may be affixed to the battery adapter structure using a number of fasteners 725, such as, for example, screws. The cap 1300 may include a positive terminal 710 and a negative terminal 705 which may be connected to conductor 1430 and 1440 of FIG. 11 by soldering.

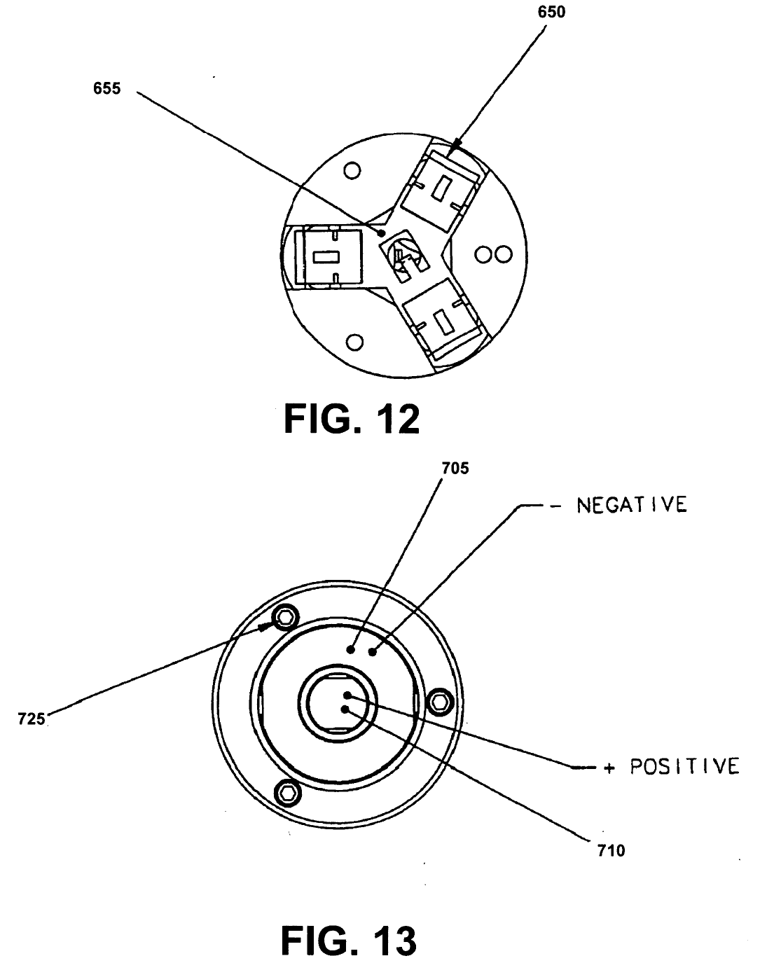

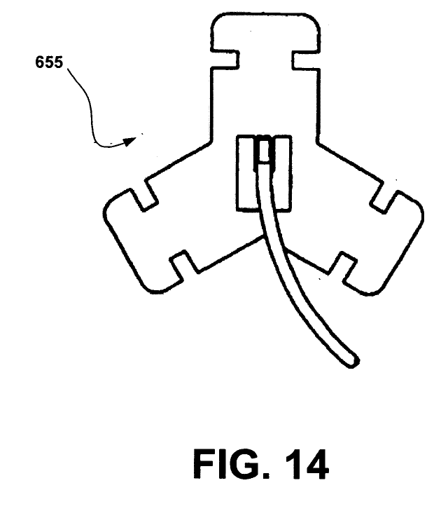

FIG. 12 shows a top view of the battery adapter with the top cap not shown to illustrate the conductor assembly according to an embodiment of the present invention. The conductor shows in FIG. 12 may be the negative conductor. The negative conductor assembly may include, for example, a number of battery contacts 650 that are configured to be biased against a unitary conductive clip 655. A wire conductor (not shown) may be soldered to or otherwise brought into electrical contact with clip 655 and to negative terminal 705 of FIG. 13. A similar set of battery contacts and unitary clip may be used to create the positive conductor assembly FIG. 14 shows a bottom view of a unitary conductive clip 655 according to an embodiment of the present invention. The conductor 655 may be a clip as shown in FIG. 14 in which wire conductors may be attached by soldering or other common means of connecting electrical contacts.

The general construction of embodiments of the present invention that are configured to utilize noncommercial batteries and the constructions of the present invention that are configured to use commercial batteries differ primarily only with respect to the interface of each adapter to the battery tube as will be readily understood from the present disclosure.

Numerous other configurations of a battery adapter may be implemented based on the present disclosure. While the invention has been described with reference to specific preferred embodiments, it is not limited to these embodiments. The invention may be modified or varied in many ways and such modifications and variations as would be obvious to one of skill in the art are within the scope and spirit of the invention and are included within the scope of the following claims. What is claimed is:

1. An apparatus comprising:
a tube, the tube being configured to hold a battery;
a venting portion being configured to be disposed within the housing, the venting portion being configured to permit the flow of gasses from within the tube to an exterior of the tube; and
a membrane disposed over the venting portion, the membrane being configured to rupture when a high pressure builds up within the tube.

2. The apparatus of claim 1, further comprising:
an interface, the interface being configured to connect the apparatus to a device.

3. The apparatus of claim 2, further comprising:
a battery, the battery being configured to reside within the tube, whereby power may be supplied from the apparatus to the device via the interface.

4. The apparatus of claim 2, further comprising:
a fastener, the fastener being configured to secure the apparatus on to the device.

5. The apparatus of claim 1, wherein the membrane is configured to rupture at a pressure of greater than about 1,000 psi.

6. The apparatus of claim 1, wherein the membrane is configured to seal the inside of the tube from environmental moisture.

7. The apparatus of claim 1, wherein the membrane is configured to permit self-regulation of atmospheric pressure within the tube due to changes in an environmental atmospheric pressure.

8. The apparatus of claim 1 wherein the housing is a substantially rigid housing.

9. The apparatus of claim 1, wherein the membrane is disposed on the bottom portion so as to be inside of the tube when the bottom portion is affixed to the tube.

10. An apparatus comprising:
a housing made of a substantially rigid material, the housing being configured to hold a battery;
a bottom portion, the bottom portion being configured to be disposed at an end of the housing, the bottom portion having a vent; and
a membrane disposed over the vent of the bottom portion, the membrane being configured to rupture when a high pressure builds up within the housing.

11. The apparatus of claim 10, further comprising:
an interface, the interface being configured to connect the apparatus to a device.

12. The apparatus of claim 11, further comprising:
a battery, the battery being configured to reside within the housing, whereby power may be supplied from the apparatus to the device via the interface.

13. The apparatus of claim 1 1, further comprising:
a fastener, the fastener being configured to secure the apparatus on to the device.

14. The apparatus of claim 10, wherein the membrane is a textile, the textile being configured to substantially seal the inside of the housing from receiving moisture form an environment outside of the tube.

15. The apparatus of claim 10, wherein the membrane is a rubber membrane.

16. The apparatus of claim 10, wherein the membrane is configured to seal the inside of the housing from environmental moisture.

17. The apparatus of claim 10, wherein the membrane is configured to permit self-regulation of the atmospheric pressure within the inside of the housing due to changes in an environmental atmospheric pressure.

18. The apparatus of claim 10, wherein the vent is defined by a plurality of holes in the bottom portion.

19. The apparatus of claim 1, wherein the membrane is disposed on the bottom portion so as to be inside of the housing when the bottom portion is affixed to the housing.

20. A method of making a battery adapter, comprising:
providing a housing, the housing being configured to hold a battery;
providing a bottom portion, the bottom portion being configured to be disposed at an end of the housing, the bottom portion having a vent; and
providing a membrane disposed over the vent in the bottom portion, the membrane being configured to rupture when a high pressure builds up within the housing.

21. The method of claim 20, further comprising:
providing an interface, the interface being configured to connect the apparatus to a device.

22. The method of claim 21, further comprising:
providing a battery, the battery being configured to reside within the housing, whereby power may be supplied from the apparatus to the device via the interface.

23. The apparatus of claim 20, wherein the membrane being provided is a textile membrane, the textile membrane being provided to substantially seal the inside of the housing from receiving moisture form an environment outside of the tube.

24. The apparatus of claim 20, wherein the membrane is a rubber membrane.

25. The apparatus of claim 20, wherein the membrane being provided is configured to seal the inside of the housing from environmental moisture.

26. The apparatus of claim 20, wherein the membrane being provided is configured to permit self-regulation of the atmospheric pressure within the inside of the housing due to changes in an environmental atmospheric pressure.

27. The apparatus of claim 20, wherein the membrane is provided to be disposed on the bottom portion so as to be inside of the housing when the bottom portion is affixed to the housing.
